(19) United States
(12) Patent Application Publication
(10) Pub. No.: US 2004/0139468 A1
(43) Pub. Date: Jul. 15, 2004

(54) Framework for maintenance and dissemination of distributed state information

(76) Inventor: Taylor W. Kidd, Portland, OR (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/653,714

(22) Filed: Sep. 2, 2003

Related U.S. Application Data
(60) Provisional application No. 60/407,839, filed on Sep. 3, 2002.

(51) Int. Cl. H04N 7/173; H04N 7/16

(52) U.S. Cl. 725/86; 725/115; 725/145; 725/116; 725/146

(57) ABSTRACT

A method and apparatus for providing digital services in a peer-to-peer environment in which broadband back-channel communications from a client to a central server and broadband peer-to-peer (client-to-client) communications are not available. A plain old telephone service (POTS) is utilized to enable relatively slow modems associated with client set top boxes to communicate latency tolerant information with one another at relatively low data rates. An application is broadcast from a head end server to client device subscribers. The application creates or includes a data structure comprising a state for an interactive game, bulletin board or other application in which a number of users are interested in being apprised of changes to the data structure representing the game or bulletin board.

### CROSS REFERENCE TO RELATED APPLICATIONS

This application claims benefit of priority to Provisional Application Serial No. 60/407,839 filed Sep. 3, 2002.

### COPYRIGHT NOTICE

A portion of the disclosure of this patent document contains material (code listings and message listings) to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2002 OpenTV, Inc.

### BACKGROUND OF THE INVENTION

1. Field of the Invention

The present invention relates generally to the field of interactive television and, more specifically, to peer-to-peer dissemination of information maintained in a database accessible to a community of users in a distributed computing environment.

2. Description of the Related Art

New forms of television communication include the possibility of interactive television in which not only does the broadcaster send computer programs to the viewer, but also in some cases the viewer can send information back to the broadcaster. Content from the broadcaster typically includes network TV programs and commercials, as well as web pages, interactive televised computer programs, graphics and text, and other items. At the same time, the viewer can request information from the broadcaster or send data via the television device. Users or viewers may interact with the systems by ordering advertised products or services, requesting specialized information regarding particular programs, or navigating through pages of information.

At the center of this communications stream is the set-top box (STB), which receives the broadcast content and connects to the television set and typically sits on top of it. This STB operates what is referred to as middleware, consisting of computer programs, which control the flow of broadcast programs (both TV and computer) and Internet traffic as well as data from the viewer. For example, OpenTV of Mountain View, Calif. provides middleware for the STB which defines a distributed execution environment comprising a head-end server and a host of client STBs. Although information is typically sent from client STBs to the head-end server, there is also a possibility of client-to-client communications via this system.

Broadcast applications, such as interactive games, programming or entertainment can exist for several receiver environments including those with and without back-channel connections between the client STB and the head-end server. Many applications already operate in the environment. One example of such an application is the Weather Channel. Included in some of these applications is a back channel for transferring information from a user client (viewer) at the STB to the broadcasters at the head-end server.

In other media, systems exist which enable transfer of information from one end-user to another via a server. See, for example, U.S. Pat. No. 6,047,327 by Tso et al. entitled System for Distributing Electronic Information to a Targeted Group of Users. The Tso et al. patent discloses a method for moving information through network services using wide area networks, local area networks, and telephones networks. An example of such an application is an e-mail system implemented by communication between clients via a central server. Instead of relying on the efforts of a user to find and retrieve information, the Tso invention allows an InfoCast server to send information, or a pointer to the information such as a uniform resource locator (URL), directly to the user. What information is sent to the user is dependent on various factors, including: the location of the user; the time of day; and the information contained in a user profile. The user profile indicates the areas of interest of the user and can be dynamically adjusted based on user feedback. The Tso system has the advantage of allowing information and content providers to take an active role in the distribution of information. It allows information providers to target particular audiences for receiving information and advertisement. This ability to “focus” the dissemination of information allows information providers and marketers to only send information to users who might be interested in that information, reducing excessive waste of bandwidth and transmission capability. Specifically, the Tso system allows the division of a general audience into different segments of targeted audiences at a fine level of granularity based on the criteria used.

U.S. Pat. No. 5,558,339 by Perlman, teaches an apparatus and system for recording and replaying the interaction between a plurality of players of a video game. The Perlman system includes a computer for recording and replaying the interaction between a plurality of players of a video game. The computer comprises: 1) a network interface coupled to a network; and 2) client application software executing in the computer, where the client application software includes: a) processing logic for saving game information indicative of the interaction between a player of the plurality of players and a video game executing on the computer; b) processing logic for connecting the first computer to a server coupled to the network; and c) processing logic for uploading the game information to a server memory coupled to the server. The Perlman computer of also includes: a) processing logic for downloading the game information from a server memory coupled to the server; and b) processing logic for executing the video game on the computer using the game information in place of input from the player.

U.S. Pat. No. 4,570,930 by Matheson teaches system, method and station interface arrangement which permits video games to be played over a telephone network. Communications delay between the games is mitigated by transmitting local player position data to a remote game, the position data being detected at a local game during a current “generation” but the position data not being used by the local and remote games until the next generation and the transmission occurring during the time interval in which the current generation is being run at the local game. The position data can be encoded so that errors, e.g. transmission errors, may be detected. Detected errors may be corrected by retransmitting the prior transmitted local position data. In addition, the games may be synchronized or resynchronized by transmitting a frame count along with the position data. The frame count may identify by order of succession the respective local and remote position data so that the games obtain and remain synchronized.

U.S. Pat. No. 4,572,509 by Sitrick teaches a system of distributed video game apparatus which are capable of exhibiting an interactive single identity game. In one embodiment there is provided a distributed game system comprising a plurality of video game apparatus, selectively inter-linkable to form a homogenous single identity game or as a peer game in the single identity system. The function of each video game apparatus can be defined at the start of game play. Each video game apparatus has a user input device, and can have its own video display, or a master video display can be provided for the whole system. As a single identity game system, each display, or the master display, can display the composite display resulting from the totality of peer game interaction. Alternatively, the display can provide individual peer game information. Individual peer game information can be communicated either globally or individually to and from selected one of the peer games. The system can provide for generating global and individual peer game displays to the selected display.

Although information typically flows from a client to a server, a connection can be made to transfer the e-mail to another client on the system. Although speedy delivery of e-mail is desirable, an e-mail server is free to move signals at a comparatively leisurely pace with respect to other applications.

As another example of multiple client interaction, games can be played between clients on a computer server. Currently games can be played over the Internet in real-time or in non-real-time. Real-time games, for example, virtual tank battle games, require that information flow quickly and continuously between players in near real time. Non-real-time games do not require such an immediate flow of data, nor do they require that both players be present simultaneously. Chess, as it is typically played over the Internet, with opponents possibly pondering for hours their next move, is an example of a non-real-time game. Chess can be played through e-mail, on telephone answering machines, or through the mail. In order to maintain progress of the game, a method is needed to track and update the state of the game at each move. U.S. Pat. No. 5,899,810 by Smith, entitled Distributed Game Architecture to Overcome System Latency teaches a method for tracking game states within a real-time interaction, where many individual states may be updated at once. The Smith system provides for interactive play between distributed users of a computer game set in a virtual world. The system involves a host computer and a plurality of client computers interconnected by a data communications network. The host computer supports a host program which tracks and coordinates the definitive state of the game. Each of the client computers supports both a display program component and an interaction program component. The display program component is responsive to messages received from the host computer and to local user input for displaying a virtual world and, within that virtual world, proxies representing the users of the various client computers.

Another example of multiple client interaction is an electronic community calendar. Information is posted on the electronic community calendar and sent to either a whole community or only to those who request access to this information. In a community application, information can be updated when necessary and sent to the entire community.

The above-mentioned real-time and non real-time applications are effective because servers are able to dedicate a requisite amount of bandwidth to the applications' proper execution. Due to the fact that application information exchanged in the examples above requires that data be sent back and forth between servers and clients, they can be created for an interactive television system in which head-end servers and client STBs communicate over a back channel connection. Unfortunately, there are many types of distributed applications that will not work in an interactive television environment because of either limited or non-existent dedicated return channel bandwidth to such servers or because of problems due to scaling. Moreover, in many communities, there may be no Internet Service Provider (ISP) or head-end server accessible to the client STBs. In this case there is a need for a distributed state dissemination system, which enables dissemination of distributed state information peer-to-peer between a group of users without sending the information to some centralized server for dissemination to other clients.

There is also a need to broaden the spectrum of distributed services offered in such remote communities and other more sophisticated communities, without requiring changes in either the receiver hardware or the telecommunications infrastructure supporting an interactive television solution provider. Thus, there is a need for a system that transfers data in the background without interfering with the flow of broadcast and/or interactive signals and in some instances, between clients or subscribers without benefit of a server.

### SUMMARY OF THE INVENTION

Those applications in the class discussed in the Background section, such as e-mail, electronic community calendars, bulletin boards, etc., share common constraints. First, the application is distributed over many client receivers or STBs. Second, the receivers/clients involved in the particular applications are frequently a small subset of all the receivers or clients being served by the head end. Third, those clients outside of this small subset of clients should be excluded from receiving the information being exchanged between the small subgroup of clients. Fourth, the required rate of information exchanged may be relatively small. Fifth, the information is latency tolerant, that is, the client or viewer does not mind if the information is a few minutes old or, in some cases, a few hours old.

The methods and apparatus described herein enable the provision of digital services in a peer-to-peer environment which may be viewed as a distributed community accessible database. In one embodiment, plain old telephone service (POTS) is utilized over which relatively slow modems associated with a client set top box communicate with each other to communication latency tolerant information at relatively low data rates. This feature may be particularly desirable in communities that do not have broadband services to support peer-to-server communications. The contemplated embodiments may further enable the provision of digital services at low cost without the need for a central organized infrastructure. In one embodiment, an application is broadcast from a head-end server to client device subscribers. The application creates, or includes, a data structure comprising a state for an interactive game, bulletin board, or other type of application in which a number of users are interested in being apprised of changes to the data structure representing the game or bulletin board.

The contemplated embodiments may further enable decentralized dissemination of information to a large number of users. As described above, each user receives an application from a head-end (e.g., via a broadcast stream). The application runs as a local instantiation of the application on the users set top box. The application further has an associated data structure which represents a state of the application. Users may belong to different classes having different access privileges to the application and corresponding data structure. For example, one class of users (e.g., players in an interactive game) can change the state of the application and its corresponding data structure, while other users (non-players) can only view the application and its state as represented by the data structure as it is rendered on the set top box display. In one embodiment, one user can be assigned as a “server”, being responsible for dissemination of changes to the data structure, though such an assignment isn't necessary.

In any case, local calls may be made between STB clients or peers to communicate the data structure and changes thereto to each instance of the application running at each set top box. The communication of the data structure changes is generally limited to those users belonging to a relevant subgroup of total users. The application which is broadcast from the head-end may be self-configuring and sets up the data structure according to the needs of the local user group. The application may further appoint several users to be available as servers for the receipt and dissemination of information in the distributed community accessible database containing latency tolerant information over an ordinary telephone system (POTS). In one embodiment, an application is broadcast from a head-end to a group of users and changes to a data structure associated with the application are disseminated via peer-to-peer communications over an ordinary telephone system.

### BRIEF DESCRIPTION OF THE DRAWINGS

FIG. 1 is an example of an interactive television system;

FIG. 2 is an illustration of one embodiment of a group of STBs in communication over a POTS;

FIG. 3 is an illustration of one embodiment of processing that occurs during receipt of an application at a STB;

FIG. 4 is an illustration of one embodiment of processing that occurs upon receipt of a data structure update;

FIG. 5 is an illustration of one embodiment of processing that occurs in initializing a local data structure;

FIG. 6 is an illustration of one embodiment of the processing that occurs upon receipt of a data structure update;

FIG. 7 is an illustration of one embodiment of processing that occurs during dissemination of data;

FIG. 8 illustrates one embodiment of a data structure; and

FIG. 9 is an illustration of one embodiment of processing that occurs after a data structure update has been received and stored.

### DETAILED DESCRIPTION

In one embodiment, a distributed data base is provided in which certain associated operations may be performed. Examples of associated operations include query and return; forward message; and request and process a change in a distributed data base. These operations can be distributed over space and time. In a spatial distribution, an operation on or associated with the distributed database is distributed over a variety of computers. For example, the operations, query and return, forward message, and request and process operation may be distributed over space in the sense that an operation will not necessarily be distributed to every computer or server at once. Rather, such operations may be distributed over space by communicating with only one computer or another at a given time. An operation may also be distributed over time in the sense that individual parts of the database may receive a particular operation at different times. That is, a particular computer may receive the operation now, in one hour, or in five hours.

In one embodiment, a user initiates an operation in association with the distributed data base and associated processor(s) act on the operation. For example, a user may (1) issue a query to the distributed data base which then returns a result; (2) submit a query or message to the distributed data base which is then forwarded to another user; or (3) submit a request to the distributed database which then processes the request to change the internal state of the data base.

The distributed database may be linked in various ways. For example, the database may be linked via a central server with directories and associated database data structures. Alternatively, the database may be linked in a peer-to-peer structure. In a peer-to-peer structure, a method may be provided to maintain the coherency of the distributed database, to update data items, and dispense with updated data items. The distributed database, and distributed processing system with which the distributed database is associated, may be linked together using broadband, narrowband, or some other suitable communication technology. In one embodiment, contextual keywords are provided so that the system may automatically issue abbreviated commands such that in the context of a current activity or data state, the system, sender, or receiver of the commands perform certain actions which correspond to the current context.

For example, instead of passing a megabyte of information between users, a contextual keyword may be used to enable a peer to communicate the same information to another peer or user. In such an embodiment, the recipient peer may calculate, or otherwise determine, the megabyte of information based upon the received keyword and any associated parameters which may accompany, or be indicated by, the keyword. The use of contextual keywords may involve a trade off between communication bandwidth and computational power. Contextual keywords implicitly rely on an agreement or understanding of a context between peers or users. That is, both peers/users understand the context or application space in which they are operating. Thus, contextual keywords comprising short commands issued between peers in a particular context may provide a robust communication mode among peers or other entities communicating within a distributed computing environment.

Contextual keywords may be an adaptive, automated process wherein a set of keywords can be established between different peers. For example, in a chess game, one way of communicating or rendering an image of a chessboard is to send the actual image in a file (for example a gif or png file) comprising megabytes of data, which requires a comparatively large amount of bandwidth. As an alternative, if two or more users know and understand their common context, for example, that they are playing a chess game, and have a common contextual language to express moves and positions on a chess board, then, the users may establish and use the abbreviated contextual language comprising contextual keywords instead of sending the relatively large gif or png file representing the chess board or a new move on the chess board. Each user sends or receives contextual keywords, generates data, and performs contextual operations in accordance with the contextual keywords and the current context. Thus, the keywords are dynamic in that a particular key word may imply a different operation in a different context. For example, an “initiate game” command may generate a chessboard and chess men in a chess game context and generate a checker board and checkers in a checker game context.

Thus, in the context of a chess game, for example, both users know how to represent the chessboard and know how to represent moves on the chessboard so that an abbreviated language comprising contextual keywords is provided to communicate large amounts of information in context via short commands. Thus, individual moves or entire chess games of moves can be communicated between users using the contextual keywords instead of entire gif images. The contextual keywords may require less bandwidth to communicate but may require more processing or computation by a user once the contextual keyword is received.

The query and return, forward messaging, and request a process to effect a change in the distributed data base described herein are useful in a variety of application spaces, including any distributed computational environment, television, entertainment, Internet, games, bulletin boards and emails.

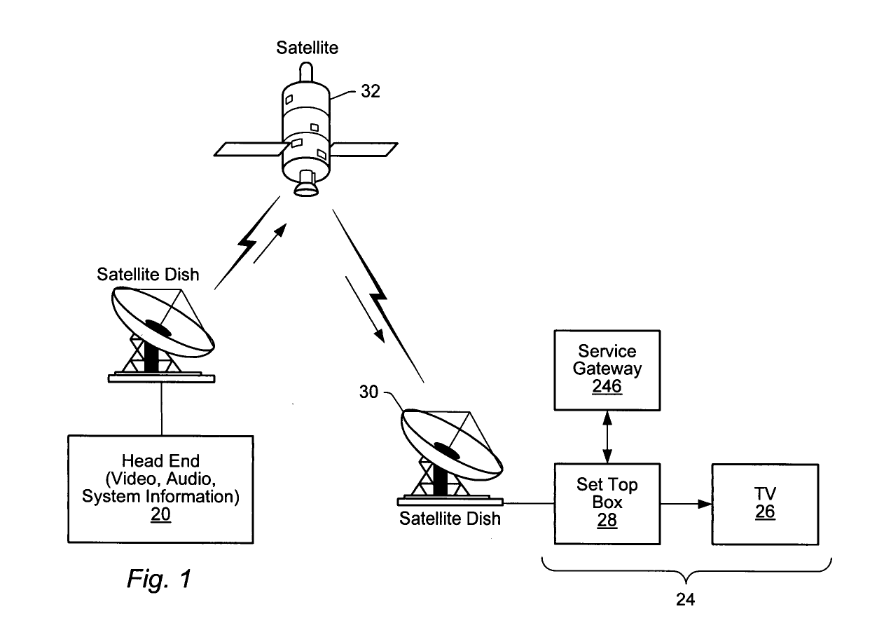

Turning now to FIG. 1, a diagram illustrating the distribution of interactive television applications, television programs (audio and video) and system information (e.g., number of services, service names, event names, event schedules) from a source server to a viewer at a client device is shown. The system includes a head end 20, which may be coupled with a video and audio device (not shown) that feeds a particular video with associated audio to the head end. The audio-video-interactive signal contains television programs or similar audio-video content, as well as interactive content such as control signals, system information, and interactive applications. The signals may be analog or digital and transmitted via a transmitter to a receiving system 24. The receiving system comprises a client device 28, such as a set top box, and a viewer display 26, such as a television set. The client device 28, however, may be a cellular telephone, personal data assistant or any other electronic device capable of receiving electronic information. The information transmitted by the head end 20 may be transmitted to the receiving system 24 in various ways. For example, the transmitted information may be sent to the receiving system 24 via a broadcast signal such as a satellite transmission. The receiving station 24 may also be configured to receive signals via a modem channel or cable. The receiving system 24 may include, for example, a television 26 connected to a set top box 28. The set top box 28 may be attached to a receiving antenna 30 for receiving information from a satellite 32. The receiving station antenna 30 passes the interactive television signal to the set top box 28, which performs the processing functions of the receiving station 24. Once information is received through the receiving antenna 30, it may be processed by the set top box 28 and displayed on the television set 26. In this manner, audio, video, and interactive data may be received and processed by the set top box 28. The signals transmitted via a broadcast carousel or modem channels embody various modules, which comprise components of an interactive application. The modules may contain any type of data, such as application code, raw data, video and graphical information.

The method and apparatus described herein enable program or application information to be maintained and updated in a distributed operating environment (i.e. a shared distributed data environment) as well as a method for disseminating updates throughout a distributed processing environment. An application, for example, a chess game, is shared among a subgroup of users, e.g. subscribers who are members of a chess club, and is accessible at some level by all members of this subgroup of chess players. Each instance of this application may also entail a membership of users. Client membership to a given application, such as a chess match, may be granted to all registered users or to a subgroup of all registered users. The number of users viewing or playing a chess game is usually a relatively small portion of the entire population of viewers served by a head-end. Some or all users may have the ability to post new information on the shared distributed data environment. As another example, a community bulletin board application could have all community citizens as members, while an electronic chess game application might have only chess fans as members.

A client or user is granted differing levels of authority or privileges with regard to this shared distributed data environment, such as for viewing (e.g., watching or receiving updates on a chess match) or for altering (e.g., a player in a chess match). For instance, whereas all members of a chess application might be allowed to view an ongoing chess match, only two members, the opponents in the match, may be allowed to alter data to move chess pieces around the board. A third member might be given access as a referee to oversee and approve or overrule player moves as they occur, prior to dissemination to the group of chess club members. The chess application can be accessed by anyone with authorization, that is, who is an approved member of the chess club group. Such a club typically comprises a subgroup of registered users served by a head-end server. A subscriber user can be a member of more than one group simultaneously, running a plurality of concurrent applications on a STB. Similarly, a subscriber may approve user inputs to a community bulletin board before dissemination to a group of users.

In one embodiment, an application that is interactive between peers or clients may be updated to different states on a continuous basis. When one member of a group updates the state of the application, this user does so by changing the state of the local application on his STB. For example, moving a chess piece in a chess match updates the local state of the data structure holding the state of the chess pieces on a virtual chessboard. The update to the local application data structure, which constitutes a state change, is later transferred to all of the corresponding applications on the set top boxes of the remaining members of the chess club group. In one embodiment, the communication of the state change in the data structure is communicated in a peer-to-peer dissemination mode of communication—that is from one user directly to another user. In systems in which a back channel is provided, data can be sent via a back channel already designed for sending other interactive TV data from a client subscriber user to a broadcaster. In a back channel enabled interactive television (iTV) environment, updating of the application data structure on other subscriber's receivers may be a background process which is performed at times when broadcast traffic is low (i.e. late at night) so as not to interrupt the flow of other iTV data. Updates to a data structure at a server may be broadcast to members of a relevant user group, or via a single designated “server” STB, over a POTS. Alternatively, an update icon comprising a visual indicator on a user display may be sent to a group or server STB to instruct the server STB to call in to receive an update to the server STB which then disseminates the update to the other dissemination group members. The update can also take place in a more decentralized fashion, where temporarily designated servers distribute the update. Subsequently, the next update may come from an entirely different set of temporarily designated servers depending upon the state of the distributed computing environment.

In one embodiment, the local instance of the application data structure, after being updated to a new state, remains on the local STB. The receiver associated with the STB or user periodically dials out to other client STBs/receivers to transfer the updated information and post updates. The data exchange rate requirement may be very limited, consisting of no more than a few kilobytes per minute, an amount which receivers can potentially exchange in bursts (for example, one burst every hour) depending on the level of activity within the community. The application is activated on a local level and does not require that another viewer use the application simultaneously. The current state of the application can be viewed at any time by a viewer by clicking on an indicator, e.g. an icon, that appears on the local display, typically a television screen. Upon activating an icon on the display of a local STB, a server or a designated client acting as a principal forwarding agent forwards the current state of the data structure to the new user desiring to view the game. A change state icon may also be displayed indicating that new information is available in a database to which the subscriber belongs. For example, when a player moves a chess piece, the data structure state change is communicated to chess club members. Upon receipt of the new data, the chess club member's local STB application displays an icon indicating that a player has made a move and a new chess board is available showing the chess player's move.

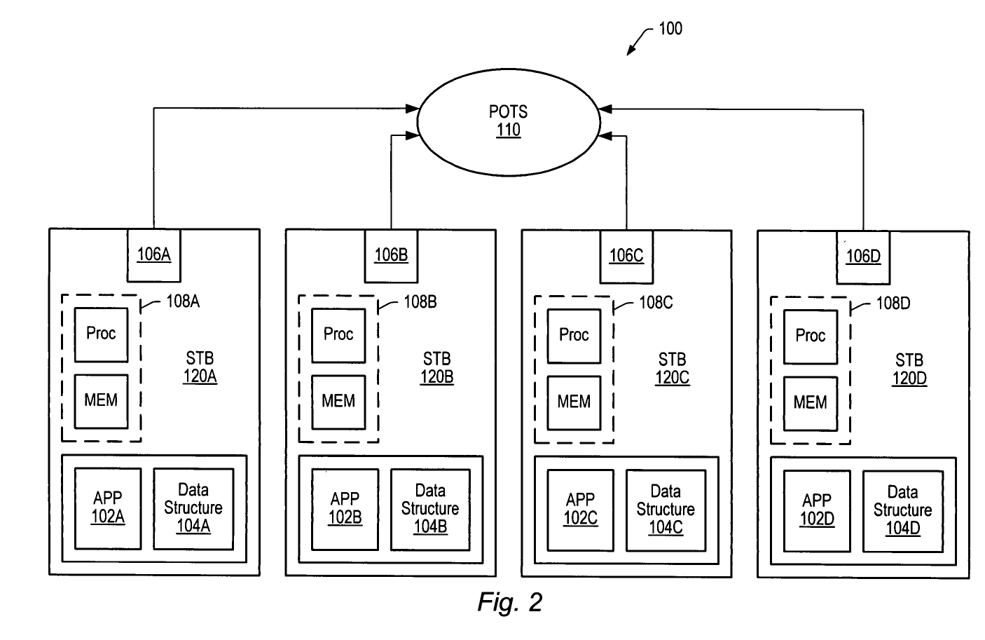

Turning now to FIG. 2, one embodiment corresponding to the above described method and mechanism is depicted. In the example shown, a system 100 including four clients (120A-120D) interconnected via a plain ordinary telephone system (POTS) 110 is illustrated. Each of the clients 120A-120D may represent STBs. As already mentioned, other types of clients and methods of interconnect are both possible and are contemplated. In the example shown, a chess game is provided as an application 102 that is played between two clients 120 over an interactive television system, for example, the OpenTV® network system as shown in FIGS. 1 and 2. Elements referred to herein with a particular reference number followed by a letter will be collectively referred to by the reference number alone. For example, clients 120A-120D may be collectively referred to as clients 120. In this example scenario, two persons, Tom and Jerry, play a chess game over their TVs 26 via their STBs, 120A and 120B, respectively. In addition, there are several other spectator members STBs (Gilligan 120C, and Mary-Ann 120D) belonging to the same chess club who desire to watch the play of Tom 120A and Jerry 120B. The rate of play is typically a move or two during weekday evenings, and maybe twice that during the weekends. The state of the chess game is kept in a data structure.

When it is Jerry's 120B turn to move, Jerry 120B brings up his Chess application 102B, noting that his TV 26 indicates that the local STB 120B has received Tom's latest move over the POTS, which the STB/receiver 120B renders on Jerry's TV screen 26. Jerry ponders the chess board displayed on his TV screen 26 with the new state reflecting Tom's latest move and after maybe an hour, Jerry makes a move, which the STB 120B receiver renders locally on Jerry's TV 26. By making this move of a chess piece in response to Tom's latest move, Jerry has altered the state of the local instance of the chess application data structure 104B associated with Jerry's STB 120B. Jerry can then turn off his TV and go to bed. The altered state of his local instance of the chess application data structure 104B remains in Jerry's STB (e.g., processor and memory 108B) for the time being.

At some arbitrary time later, for example, an hour later, Jerry's STB/receiver processor 108B checks and determines that there are several updates in the STB 120B message queue that need to be sent to other community STBs/receivers (member clients), one of the updates being Jerry's most recent chess move. In accordance with a delivery algorithm dependent upon a prescribed dissemination mode which in turn takes into account the characteristics of the distributed environment (e.g. previous delivery latencies experienced at the STB, urgency of the communication, and a configurable available call time) which is configurable at each STB, the STB/receiver 120B with which Jerry is associated, dials out to a second STB/receiver associated with another member of the chess club in the local area, for example, Mary Ann 120D. The two STBs, Jerry 120B and Mary Ann's 120D, exchange updates. Call time may be based on configuration parameters set by the application or the member client. The second member STB/receiver (Mary Ann) 120D, after an interval of time, then takes its own updates plus those from Jerry's receiver 120B, and sends those updates on to another STB member of the chess group, e.g., Gilligan 120C. Gilligan might add a comment or act as a referee approving or disapproving of Jerry's move. Eventually, Jerry's chess update finds its way to every member of the chess group, including Tom's STB/receiver 120A. In a case where a referee is named, all player moves must be approved by a referee prior to dissemination to the group. The next morning, when Tom turns on his TV associated with the STB 120A, an Update Icon may be displayed. Tom notices the TV is displaying a “Chess Update” icon, indicating that the chess board data has been updated with a new move. Tom requests that his receiving station (TV and STB) renders the chess update, makes a move and the process is repeated, disseminating the data showing Tom's new chess move to all members of the chess club.

As another example, members of a small community, due to its isolated location, all receive satellite TV from the same service without the benefit of a back channel connection to the head-end server. One of the applications running on the interactive TV client STB, e.g., Gilligan 120C, maintains a community calendar of events and community building reservation system. The members of the community 120A-120D use the community calendar application to submit and disseminate event and reservation information. In this example, a designated member client, e.g., Gilligan 120C, approves and processes updates to the community bulletin board.

As another example, this same community may maintain a simple and local email system using their interactive television STBs to implement an email program between subscribers 120. For example, Tom's client device 120A may disseminate and forward emails by calling either an email recipient, calling any member of the email group that has not received an email update, or calling an agreed upon intermediate which will forward the email update to their destinations. In addition to the above, updates may be tagged. For example, the email updates may be tagged to distinguish old updates from new updates and to remove the old updates that are no longer relevant.

Further embodiments may also enable broadcast announcements. For example, the mayor of a same small community may broadcast announcements to the various members of the community via a community Event & Announcement program. In this example, updates may be called into a head end for broadcast to a community of users. The head-end system may then relay the announcements to all of the STBs/receivers in the community for rendering on their TVs.

As another example, a cooking club can maintain and update a distributed database of recipes in a distributed data structure 104. When a member of the club wants a certain type of recipe, the user sends out a query that returns after several hours with the results of the search. The application embodiments described herein may then disseminate and collect the result of the queries.

In the embodiment shown in FIG. 1, each of a plurality of the set top boxes 28 receives a broadcast application from a head end. As shown in FIG. 2, each one of these set top boxes stores the application locally. Subsequent to receiving the application, a data structure 104 is created and stored locally in each set top box. Each set top box is equipped with a modem 106, which communicates over a plain ordinary telephone system (POTS). The POTS 110 enables each of a plurality of set top boxes to communicate with each other in a peer-to-peer communication mode over the POTS. The set top boxes communicate with each other to relay changes in the data set or data structure. As described above, a data structure 104 may be used to represent changes to an interactive game being played between two users at individual set top boxes for example, a chess game in which the data structure tracks player moves. In another example, a bulletin board is disseminated to each of the plurality of set boxes by as single set top box.

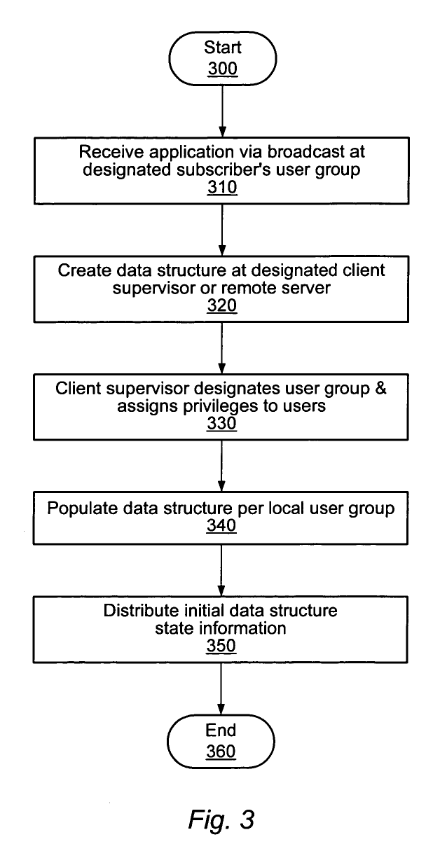

Turning now to FIG. 3, starting point 300 is entered when an application 102 at a set top box is received via a broadcast from a head end data stream as shown in block 310. At this time, a designated subscriber user group may be defined by the application. This user group may consist of a community of registered users who may want to view a newsletter of common interest among the users or it may consist of a group of users with a common interest such as a chess club. Members of the chess club are listed and utilized by the chess application, for example. Shown in item 320, the application creates a data structure, which may exist at a designated client supervisor (STB) or at a remote server. The data structure is maintained by a client supervisor or a remote server and updates to the data structure are disseminated in a peer-to-peer dissemination mode of communication between each of the set top boxes. The peer-to-peer mode of communication and data dissemination is discussed later and is referred to as the dissemination mode. In box 330, the application designates one or more of the set top boxes in the community of users a client supervisor(s) and principal forwarding agent(s). The application or client supervisor assigns privileges to users who are within the member user group. For example, a user might be assigned a role and given associated privileges such as a player, a spectator, a referee, (scribe) one who inputs data to a community bulletin board for dissemination among the members of the community, client supervisor or principal forwarding agent. As shown in item 340, the application populates the local instance of the data structure per the definition of the activity or game and of a local user group in the designated dissemination mode. The data structure may be populated with the names of the users and their contact phone numbers and privileges. The data structure may also contain the application's declared dissemination mode, which indicates how the users within the group will disseminate data between each other. As shown in 350, an initial populated data structure is disseminated among the users showing an initial data structure state information. This process is terminated at block 360. Alternatively, a local instance of the data structure is created at each STB for game play.

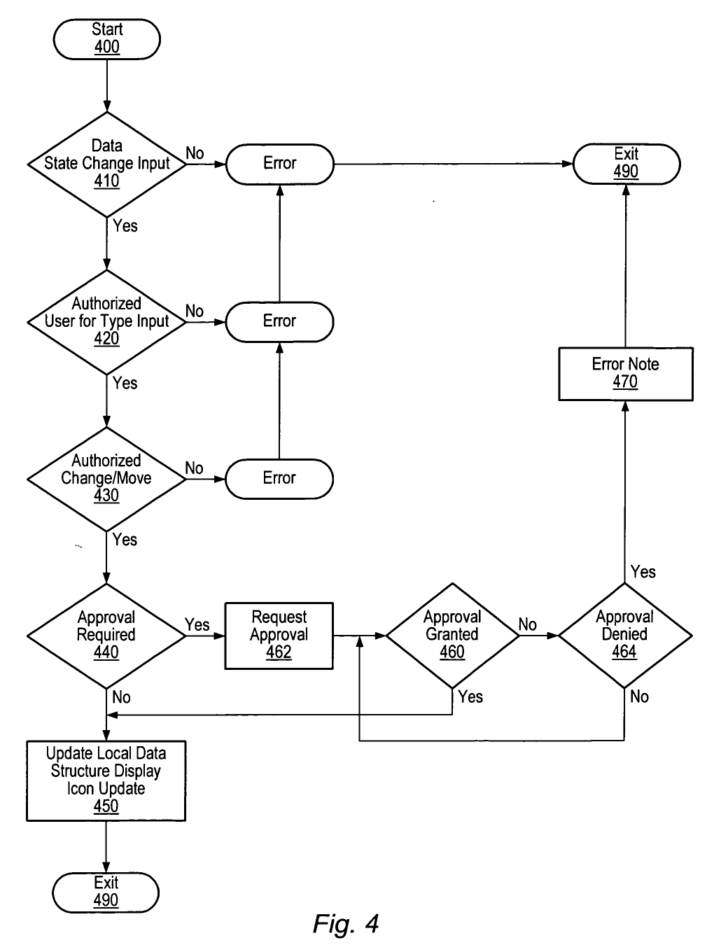

Turning now to FIG. 4, when a set top box at a user receives input from another set top box it enters the starting point at block 400. At block 410, a test is performed to determine if the input indicates a change in state. If the input from another set top box indicates a change in the data structure then the process as shown in FIG. 4 proceeds to decision block 420. If the input from the set top box is not a change in the data state or data structure then the process optionally generates a message which may or may not indicate an error and exits at block 490. If the input at the set top box is a change in data state or the data structure, then the process proceeds to block 420 where it tests to see if the user originating the data state change is authorized for this type of input or change to the data structure. For instance, if a user designated as a spectator has made a change or attempted a change in the data state by moving a chess piece, this unauthorized move may generate an error. If the user is authorized for the type of input received, then the process proceeds to block 430 where the process checks to see if the change in the data state is valid, that is, is this a game move which is allowed by the rules of the game.

If the game move is authorized, then the process checks to see if approval is required for the game move in block 440. If approval is required, then a request for approval is issued in block 462. The approval is tested to see if it has been granted in block 460 and once it is granted, the process proceeds to block 450 where the process updates the local instance of the data structure and displays an update icon on the display associated with the local set top box. The process then exits at block 490. If in block 460, approval has not been granted, the process checks to see if approval has been denied 464. If approval has been denied in block 464, an error message is issued 470 and the process exits at block 490. If approval has not been denied and the approval has not been granted, then the process loops back to block 460 to test again for approval granted and approval denied. In block 440, if approval is not required, then the process continues to block 450 where the process updates the local instance of the data structure and displays at update icon at the display associated with the local set top box. The process then exits at block 490.

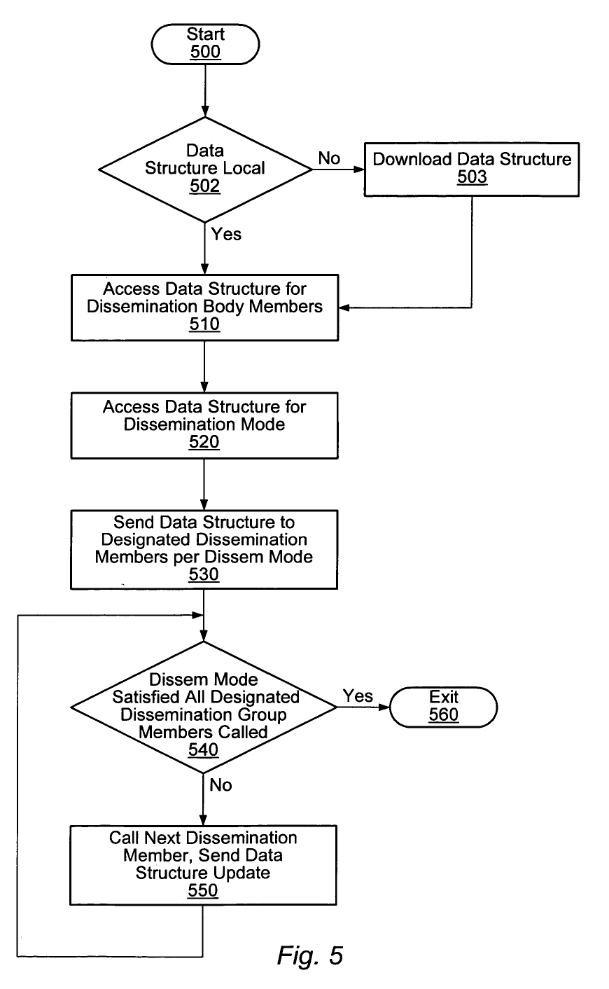

Turning now to FIG. 5, the process for determining the dissemination mode and the dissemination mode requirements is described. As shown in FIG. 5, the process begins at block 500 and proceeds to block 502 where the process determines if the data structure is local or remote. If the data structure is local, then the process continues to block 510 where the process accesses the local data structure for the dissemination body and members. If in block 502, the data structure is not local then the set top box accesses a remote server to obtain the data structure. The data structure is downloaded in block 503 to the calling set top box and the process proceeds to block 510 for access to the data structure. In block 520, the process accesses the data structure to determine the dissemination mode. Once the dissemination mode is obtained, the process at the local set top box sends the change in the data structure to a designated dissemination member per the rules of the dissemination mode, as shown in block 530. In one embodiment, the data structure also includes a dynamic dissemination mode/action indicator which indicates an action to be performed by the receiver which receives the data structure. The process then determines whether the dissemination mode has been satisfied in block 540. If the dissemination mode has been satisfied, then the process exits at item 560. If the dissemination has not been satisfied (e.g., the action indicated by the action indicator has not been performed), the process calls the next dissemination mode member and sends that dissemination mode member a data structure update as shown in block 550 and the process returns to block 540 to determine whether or not the dissemination mode has been satisfied and the process repeats until the dissemination mode has been satisfied and then the process exits at item 560. The dissemination mode may be defined at startup based on the available resources distributed among the group members.

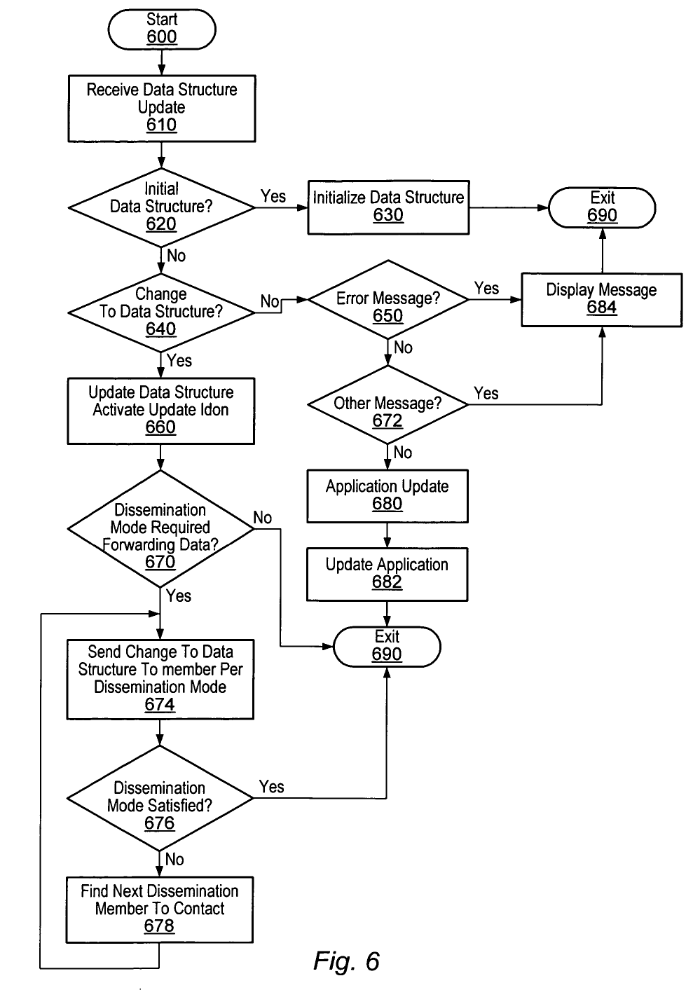

Now turning to FIG. 6, the process starts at block 600 and a data structure update is received as shown in block 610. The process then determines whether or not this data structure update is an initial data structure being sent as determined by process 620. If this is an initial data structure, then the process initializes the local instance of the data structure at 630 and exits at item 690. If this is not an initial data structure command, the process determines at decision block 640, if this is a change to the data structure. If this is not a change to the data structure, the process determines 650 if the input is an error message. If this is a change to the data structure as determined in data block 640, then the process proceeds to item 660 and updates the data structure at the local set top box and activates the update icon for display to the user on the display associated with the local set top box. The process then proceeds to item 670 to determine if the dissemination mode requires forwarding of the data structure to another user. For example, a dynamic dissemination action indicator may indicate the receiving device is to forward the data structure and corresponding updates to at least one other receiver. If the dissemination mode requires forwarding to another user, the process proceeds to block 674 where the set top box sends the change in the data structure to another member or peer pursuant to the declared dissemination mode. The process then determines if the dissemination mode has been satisfied in block 676. If the dissemination mode has not been satisfied, the process then finds the next dissemination member to contact and returns to block 674 where it sends the change to the data structure to the member pursuant to the dissemination mode. This process is repeated until the dissemination mode is satisfied in decision block 676 and then the process exits at item 690. Returning now to block 650, if the input is an error message then the process displays an error message in item 684 and exits in item 690. If the input to the set top box is not an error message, then the process checks in decision block 672 to determine if the input is another type of message and displays this message if answered in the affirmative. If it is determined in decision block 672 that it is not another type message, then the process checks to see if the input is an application update in decision block 680. If the input is an application update, then the application is updated in block 682 and the process exits at item 690.

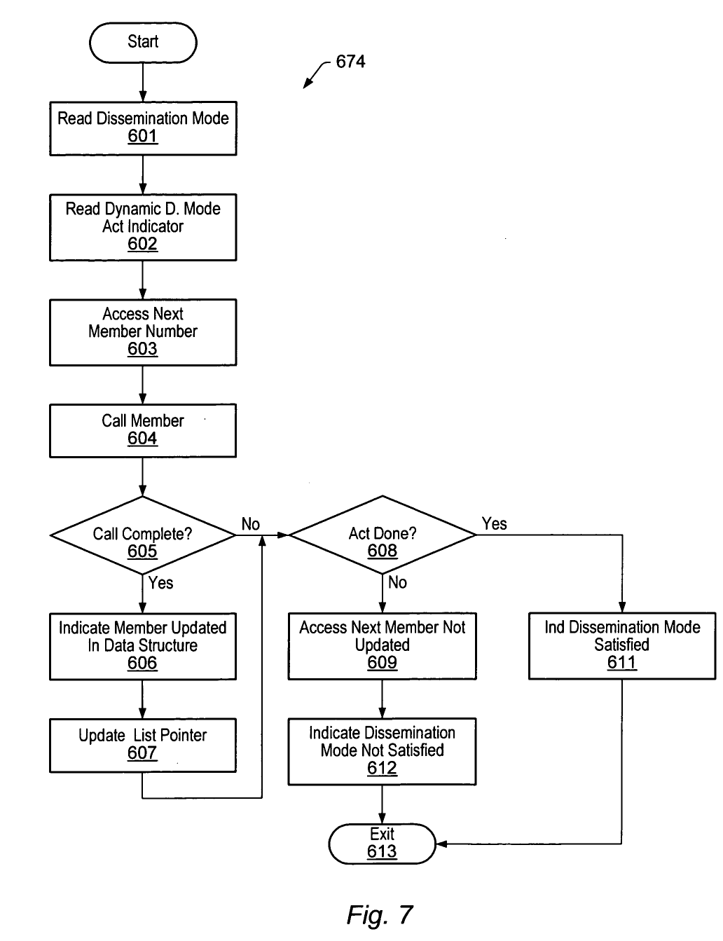

Turning now to FIG. 7, the processing steps of block 674 of FIG. 6 are shown in detail. In block 601, the process accesses the dissemination mode. The dissemination mode may be designated by a one digit numeral, such as 1-4, for example, 1) read only, 2) read and forward to 1, 3) read and forward to N, or 4) read and forward based on available call time. The process accesses the next member phone number in block 603. The process then calls the member in block 604. In block 605, the process checks to see if the call has been completed. The call is complete if the called member's STB answers the phone and accepts the data transfer. If the call is complete the process proceeds to block 606 and indicates that the called member has been updated.

The data structure may also provide a field in which each member has an indicator showing the version number of the latest update. The calling client or the called client may indicate in this field that the called client has been updated by updating the version number for the called client and placing it in the member updated field. The process then updates the member list pointer to the next member to be called and proceeds to block 608. If the called member does not answer, has a busy signal, or a voice answers without accepting the data transfer, the call is not complete and the process goes to block 608. In block 608 the process checks to see if an act requested by the dynamic dissemination mode indicator (e.g., (1) read only, 2) read and forward to one client, 3) read and forward to N clients or 4) read and forward to as many clients as possible based on available call time) has been performed. If the act is not complete, the process indicates that the dissemination mode is not satisfied 609, 612 and exits at block 613. If the act is complete, then the process indicates that the dissemination mode is satisfied 611 and exits at block 613.

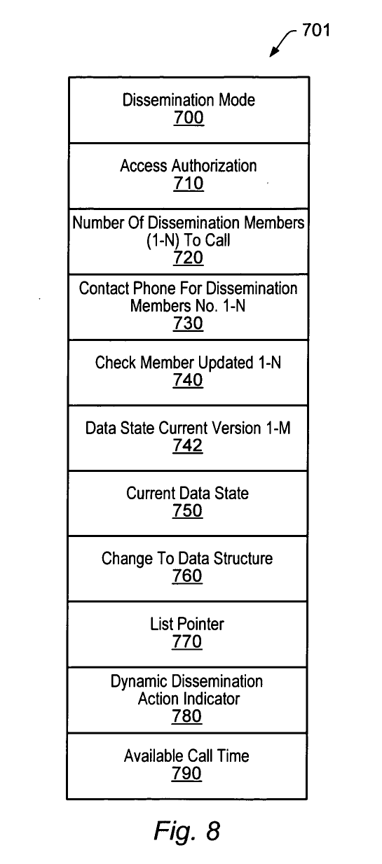

Turning now to FIG. 8, one embodiment of a data structure 701 is shown which shows a first field 700 indicating a dissemination mode. Dissemination mode can be any of a plurality of modes applicable to the peer-to-peer communication provided by the POTS. For example, the dissemination can be a call ring or a call structure wherein each member calls one other member or calls a designated number of members. In each case, the dissemination mode enables at least one peer to communicate a change in the data structure to at least one other peer until all peers within a designated group are contacted with the change in the data structure. This next field in the structure is field 710 entitled “Access Authorization”. Access Authorization indicates the player's access authorization privileges such as player, spectator, referee or scribe. For example, a player can move pieces around on a game board to another while a spectator can only watch the game, e.g., chess match. A referee can only watch the chess match but has the power to override updates to the data structure which before they are propagated to other subscribers other than the player that initially made the move. All player moves may require authorization by a referee when a referee is active in a game. The referee could be a user peer or an expert system or any other form of rule authorization software. A scribe is the author of the newsletter that has access to the data structure to draft a community bulletin board type script which is disseminated in a decentralized mode of communication to all members of the community of users in a dissemination mode communication scheme until all users have received the update.

The next field shown in FIG. 8 is field 720, which comprises a number of dissemination members to call. This is the number 1-N, which indicates in this local instance of the data structure how many other users or peers he should call to communicate a change in the data structure. In one embodiment, a local STB calls as many dissemination members as possible based on the availability of call out POTS bandwidth. The local STB thus may call 0-N members. Any members not called by the local STB may be handed off to a peer with an indicator as to where in the list of users the peer is to pick up calling in the dissemination mode. Field 730 contains corresponding phone numbers for each of the 1-N dissemination members, which the local set top box should call with the updates to the data structure. Field 740 contains a list of numbers 1-N and indicates whether each member 1-N has been updated with this particular update. Field 742 comprises the current version or change number corresponding to the current state of the database to indicate which members have the current database updated in their local instance of the application. Field 750 comprises the entire data state itself and is the local instance of the data state at the set top box. The data state represents the current state of the distributed data as known at the local STB. Field 760 represent a change to the data state which has been implemented and is to be passed along to other users according to the dissemination mode identified in field 700. Selected portions of data structure 701 may be communicated peer-to-peer based on current needs to communicate a data state change or implement a dissemination mode. Field 770 is a member list pointer which may be used to indicate a next member to be called, field 780 is a dynamic dissemination mode indicator, and field 790 represents available call time.

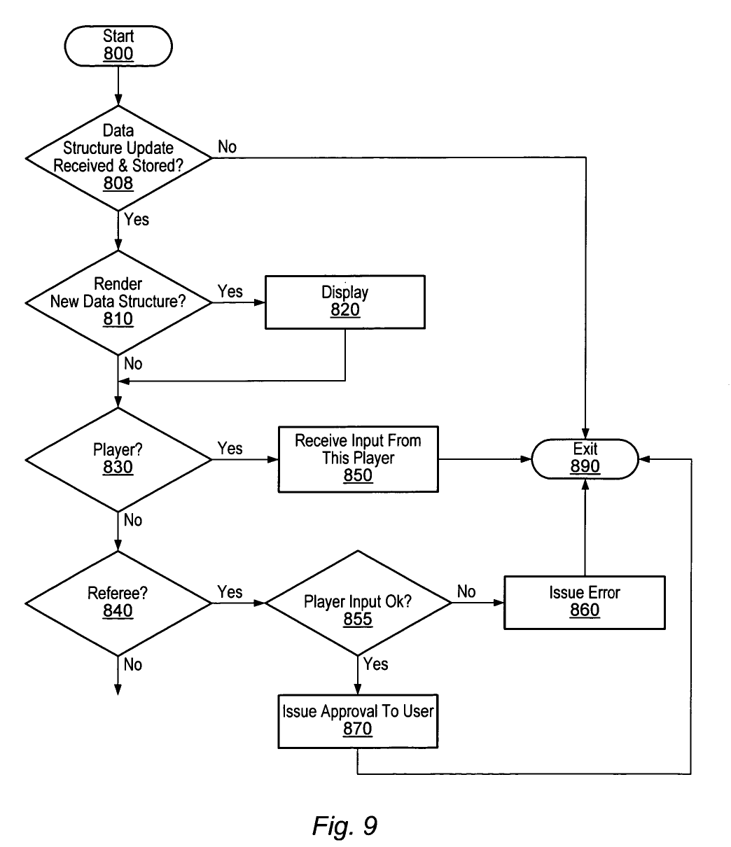

Turning now to FIG. 9, starting point 800 is entered when a data structure update has been received. Once the data structure has been received and stored 808, the process proceeds to decision block 810 where the process determines whether or not to render the data structure on the display associated with the local set top box. If the data structure should be rendered, the data structure is rendered on the display in block 820 and the process proceeds to decision block 830 to determine whether the local set top box is a user with the necessary authorization access level. If the current or local set top box has the required authorization (e.g., is a player in this example) then the process requests input 850 from this player after displaying the latest change to the data structure and then exists at block 890. If the current user at the local set top box is not a player, the process continues to determine if the user is a referee in decision block 840. If the user is not a referee, then the process exits and optionally issues an error message. If the user is a referee, then the process determines if the players' input is authorized in decision block 855. If the players' input is not authorized, the process issues an error message at block 860 and exits at block 890. If the players' input is authorized, then the process proceeds to 870, issues approval to the user to update the data structure and sends this message to the player and updates the data structure and exits at block 890.

While the above discussion has described embodiments in the context of an interactive television system, the apparatus and methods described herein may also be embodied in a distributed computer system comprising a server and a client device. In another embodiment, the present invention is implemented as a set of instructions on a computer readable medium, comprising ROM, RAM, CD ROM, Flash or any other computer readable medium, now known or unknown that when executed cause a computer to implement the method of the present invention. Still other forms of media configured to convey program instructions for access by a computing device include terrestrial and non-terrestrial communication links such as network, wireless, and satellite links on which electrical, electromagnetic, optical, or digital signals may be conveyed. Thus, various embodiments may further include receiving, sending or storing instructions and/or data implemented in accordance with the foregoing description upon a computer accessible medium.

The foregoing examples are provided for purposes of discussion only and should not be considered a limitation on the scope of the invention.

What is claimed is:

1. A method for maintaining a distributed data base comprising:
storing a distributed data base in memory associated with a plurality of computers in a distributed computing system;
performing an operation associated with the distributed data base, said operation being requested by a first peer in the distributed computing system; and
disseminating the result of the operation to a second peer in the distributed computing system.

2. The method of claim 1, further comprising:
requesting an operation comprising a query from the first peer to the distributed data base; and
returning a result of the query to the first peer from the distributed data base.

3. The method of claim 1, further comprising:
requesting an operation comprising a forward message request from a first peer to the distributed data base; and
forwarding the message to a second peer via the distributed data base.

4. The method of claim 1, further comprising:
requesting a change to the data state of the distributed data base from a first peer to the distributed data base;
processing the request for a change to the data base;
returning a result to the first peer from the distributed data base; and
disseminating the result to a second peer.

5. The method of claim 1, wherein the operation is distributed over a subset of computers in the distributed computing system.

6. The method of claim 1, wherein the operation is disseminated over time.

7. The method of claim 1, further comprising:
linking the distributed data base by a central server.

8. The method of claim 1, wherein the distributed database is distributed between peers in a distributed computing system.

9. The method of claim 1, further comprising:
sending a contextual keyword between peers representing an operation on the distributed data base.

10. A method for disseminating data state information in a distributed computing environment comprising:
receiving an application from a broadcast at a subgroup of member clients;
initializing the application in at least one member of the subgroup of member clients;
defining a dissemination mode for communication between the member clients;
initializing a data structure in at least one member of the group of member clients in accordance with the available resources of the subgroup of member clients;
initiating a data state change associated with a first member client of said member clients; and
sending the data state change from the first member client directly to at least one other member client in accordance with the dissemination mode.

11. The method of claim 10, further comprising:
if the dissemination mode is not satisfied, then finding a next member client to contact; and
either sending the data state change directly to the next member client in accordance with the dissemination mode, or passing a dynamic dissemination action indicator to at least one other member client indicating a desired dissemination action in accordance with the dissemination mode.

12. The method of claim 11 further comprising:
accessing a next member contact number;
calling the next member contact number; and
if the call is complete, then indicating in the data structure that the member has been contacted and updating a list pointer;
if an act indicated by a dynamic dissemination act indicator is complete, then indicating that the dissemination mode is satisfied;
if the act indicated by the dynamic dissemination act indicator is not complete, accessing a next member that has been not updated and indicating the dissemination mode is not satisfied.

13. The method of claim 12, further comprising:
if there is available call time, calling the next member client;
if there is not available call time, updating a dynamic dissemination act indicator to request calling at least one member client, and passing a call list and the dynamic dissemination act indicator to the next member called.

14. The method of claim 10, further comprising:
assigning data state access privileges to member clients comprising at least one of player, referee, principal forwarding agent and spectator.

15. The method of claim 10, further comprising:
receiving a data state change from a first member client at a second member client;
accessing a field indicating access authorization, to determine access privileges and necessary actions upon receipt of a data state update;
if the second member client is a player, requesting an input from the player;
if the second member client is a spectator, requesting a comment from the spectator; and
if the member client is a referee, determining whether the data state change is appropriate, and if the data state change is appropriate sending approval of the data state update to the first member client, else issuing an error message to the first member client.

16. The method of claim 10, further comprising:
accessing a third field indicating a quantity of dissemination members to call with a data state update, upon receipt of a data state update;
accessing a fourth field indicating a contact phone number for a member client;
accessing a fifth field indicating whether a member client has been updated with a current version of the data state; and
if the fifth field indicates that the member has not been updated, calling the number to send the data state change to the client associated with the number.

17. The method of claim 11, further comprising:
accessing a field indicating a current version of the data state;
determining whether the receiving client has a current version of the data state; and
accessing a seventh field comprising a current data state at the receiving client and updating the current data state at the receiving client.

18. The method of claim 10, further comprising:
accessing an eighth field comprising a change to the data structure; and
accessing a ninth field indicating a list pointer to find a client to send the data state change.

19. The method of claim 10, further comprising:
accessing a tenth field indicating a dynamic dissemination mode action indicator to determine what action to take upon receipt of a data state update.

20. A computer readable medium containing instructions which when executed by a computer implement a method for disseminating data state information in a distributed computing environment comprising:
receiving an application from a broadcast at a subgroup of member clients;
initializing the application in at least one member of the subgroup of member clients;
defining a dissemination mode for communication between member clients;
initializing a data structure in the at least one member of the group of member clients in accordance with the available resources of subgroup of member clients;
initiating a data state change associated with a first member client; and
sending the data state change from the first member client directly to at least one other member client in accordance with the dissemination mode.

21. The medium of claim 20, further comprising instructions that cause a computer to implement a method further comprising:
if the dissemination mode is not satisfied, then finding a next member client to contact and sending the data state change directly to the next member client in accordance with the dissemination mode;
if the dissemination mode is satisfied, passing a dynamic dissemination action indicator to at least one other member client indicating a desired dissemination action in accordance with the dissemination mode.

22. The medium of claim 21, further comprising instructions that cause a computer to implement a method further comprising:
accessing a next member contact number;
calling the next member contact number;
if the call is complete, then indicating in the data structure that the member has been contacted and updating a list pointer and
if an act indicated by a dynamic dissemination act indicator is complete, then indicating that the dissemination mode is satisfied; and
if the call is not complete, accessing a next member that has been not updated and indicating the dissemination mode is not satisfied.

23. The medium of claim 22, further comprising instructions that cause a computer to implement a method further comprising:
if there is available call time, calling the next member client;
if there is not available call time, updating a dynamic dissemination act indicator to request calling at least one member client, and passing a call list and the dynamic dissemination act indicator to the next member called.

24. The medium of claim 20, further comprising instructions that cause a computer to implement a method further comprising:
assigning data state access privileges to member clients comprising at least one of player, referee, principal forwarding agent and spectator.

25. The medium of claim 20, further comprising instructions that cause a computer to implement a method further comprising:
receiving a data state change from a first member client at a second member client;
accessing a second field indicating access authorization, to determine access privileges and necessary actions upon receipt of a data state update;
if the second member client is a player, requesting an input from the player;
if the second member client is a spectator, requesting a comment from the spectator; and
if the member client is a referee, determining whether the data state change is appropriate, and if the data state change is appropriate sending approval of the data state update to the first member client, else issuing an error message to the first member client.

26. The medium of claim 20, further comprising instructions that cause a computer to implement a method further comprising:
accessing a third field indicating a quantity of dissemination members to call with a data state update, upon receipt of a data state update;
accessing a fourth field indicating a contact phone number for a member client;
accessing a fifth field indicating whether a member client has been updated with a current version of the data state; and
if the fifth field indicates that the member has not been updated, calling the number to sending the data state change to the client associated with the number.

27. The medium of claim 21, further comprising instructions that cause a computer to implement a method further comprising:
accessing a field indicating a current version of the data state;
determining whether the receiving client has a current version of the data state; and
accessing a seventh field comprising a current data state at the receiving client and updating the current data state at the receiving client.

28. The medium of claim 20, further comprising instructions that cause a computer to implement a method further comprising:
accessing an eighth field comprising a change to the data structure; and
accessing a ninth field indicating a list pointer to find a client to send the data state change.

29. The medium of claim 20, further comprising instructions that cause a computer to implement a method further comprising:
accessing a tenth field indicating a dynamic dissemination mode action indicator to determine what action to take upon receipt of a data state update.

30. A computer readable medium having a data structure stored thereon comprising:
a first field indicating a dissemination mode; and
a second field indicating access authorization.

31. The medium of claim 30, wherein the data structure further comprises
a second field indicating a dynamic dissemination action indicator.
